(19) United States
(12) Patent Application Publication
(10) Pub. No.: US 2022/0094723 A1
(43) Pub. Date: Mar. 24, 2022

(54) CONTENT DELIVERY VIA DEVICE-TO-DEVICE COMMUNICATION

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Pieter Nooren, Delft (NL); Toni Dimitrovski, Boskoop (NL)

(21) Appl. No.: 17/436,990

(22) PCT Filed: Mar. 6, 2020
(86) PCT No.: PCT/EP2020/055964

§ 371 Date: Sep. 7, 2021

(30) Foreign Application Priority Data
Mar. 7, 2019 (EP) 19161190.4

(51) Int. Cl. H04L 65/1069; H04L 65/612; H04W 76/14; H04W 48/18; H04W 36/00; H04W 72/04

(52) U.S. Cl. CPC H04L 65/1069; H04L 65/4084; H04W 76/14; H04W 76/11; H04W 36/03; H04W 72/048; H04W 48/18

(57) ABSTRACT

A recipient UE (UE1) and a donor UE (UE2) are provided. The recipient UE may be configured to send a request for content delivery to the donor UE via a mobile network. The content request may include a D2D communication identifier. The donor UE may use this D2D communication identifier to establish a D2D connection with the recipient UE, if such a connectivity type is selected by the donor UE for content delivery. Having established the D2D connection with the recipient UE, all or at least part of the requested content may be delivered via D2D communication, while at the receiving side, the recipient UE may identify whether the content delivered via the D2D connection represents an at least partial fulfillment of the content request. Thereby, an efficient mechanism may provided for enabling content delivery from a donor UE to a recipient UE to take place at least in part via D2D communication.

### FIELD OF THE INVENTION

The invention relates to a device configured as user equipment (UE2) for a mobile network and for delivering content to another user equipment (UE1), and to a computer-implemented method for delivering content to the other user equipment. The invention further relates to a device configured as user equipment (UE1) for a mobile network and for receiving content from another user equipment (UE2), and to a computer-implemented method for receiving content from the other user equipment. The invention further relates to the mobile network, and to a computer program comprising instructions for causing a processor system to perform either method.

### BACKGROUND ART

A large part of the traffic on the Internet and on mobile networks is generated by content distribution, in particular distribution of audiovisual media such as video. For many years, Content Delivery Networks (CDNs) have been used to make distribution of video more efficient. CDNs build on the observation that many viewers want to see the same video. By caching (i.e., storing copies of) popular content at different locations (both geographically and in terms of the network topology), the total amount of traffic may be reduced. At the same time, CDNs may improve the delivery quality as, in general, the network routes between the nodes that play out content and the viewer's device become shorter as more caches are added in the network. It is noted that CDNs are generally considered as overlay networks that depend on one or more underlying networks to transport the content to its destination. The underlying networks may thus be considered to support the CDN or be part of the CDN.

Although CDNs originate from content delivery over fixed networks, they have become relevant for content delivery to mobile devices (also referred to as User Equipment, or in short UE) as well. Such UEs may have the possibility to cache content and make the cached content available to other UEs seeking the same content.

3GPP has formulated requirements on ‘Efficient content delivery’ in TS 22.261 [1]. This includes requirements on caches close or on UEs, such as:
the 5G system shall enable efficient delivery of content from a content caching application under the control of the operator (e.g., a cache located close to the UE),
the 5G system shall support a content caching application in a UE under the control of the operator, and
based on operator policy, the 5G system shall support an efficient mechanism for selection of a content caching application (e.g., minimize utilization of radio, backhaul and/or application resource) for delivery of the cached content to the UE.

There is thus a general need to improve content delivery between UEs.

Mobile devices may establish connections to other UEs via a mobile network infrastructure, but also via Device-to-Device (D2D) communication.

GB2537623 [2] describes a content delivery method employing a plurality of transient device-to-device (D2D) links among User Equipments (UEs) in the vicinity of a content-seeking UE and which locally cache desired content. To obtain the desired content, successive D2D links are initiated by the content-seeking UE with initial guidance from a central Femto network controller. The central Femto network controller identifies possible D2D content donor UEs in the vicinity of the content-seeking UE and indicates a probability of successfully obtaining the content through UE-orchestrated content delivery using multiple D2D links. A user then decides whether to attempt UE-orchestrated content delivery or whether to obtain the content in another way.

GB2537623, however, does not describe how to establish the D2D connection if the user decides to attempt UE-orchestrated content delivery.

### References

[1] 3GPP TS 22.261 V16.5.0 (2018 September), 3rd Generation Partnership Project; Technical Specification Group Services and System Aspects; Service requirements for the 5G system; Stage 1 (Release 16).

[2] Content delivery over D2D links, GB2537623

### SUMMARY OF THE INVENTION

It would be desirable to obtain a mechanism to enable a D2D connection to be established to a UE which is identified as content donor, for example by a CDN.

In accordance with a first aspect of the invention, a device is provided which may be configured as user equipment (UE2) for a mobile network and which may be configured for delivering content to another user equipment (UE1).

The device may comprise:
a network interface configured to interface with the mobile network;
a device-to-device (D2D) interface configured for D2D communication;
a processor subsystem which may be configured to:
   via the mobile network, receive a content request for content from the other user equipment (UE1), wherein the content request comprises a D2D communication identifier of the other user equipment (UE1);
   select between connectivity types for delivery of the content to the other user equipment (UE1), the connectivity types comprising delivery via the mobile network and delivery via D2D communication;
and if the selected connectivity type comprises D2D communication
   establish a D2D connection with the other user equipment (UE1) using the D2D communication identifier of the other user equipment (UE1);
   upon establishment of the D2D connection, deliver the content to the other user equipment (UE1) using the D2D connection.

In accordance with a further aspect of the invention, a device is provided which may be configured as user equipment (UE1) for a mobile network and which may be configured for requesting and receiving content from another user equipment (UE2).

The device may comprise:
a network interface configured to interface with the mobile network;
a device-to-device (D2D) interface configured for D2D communication;
a processor subsystem which may be configured to:
   via the mobile network, send a content request for content to another user equipment (UE2), wherein the content request comprises a D2D communication identifier of the user equipment (UE1); and
   in response to an establishment of a D2D connection with and at the request of the other user equipment (UE2), identify whether content delivered via the D2D connection represents an at least partial fulfillment of the content request.

In accordance with a further aspect of the invention, a computer-implemented method may be provided for delivering content to a user equipment (UE). The method may comprise:
via a mobile network, receiving a content request for delivery of content from the user equipment (UE1), wherein the content request comprises a device-to-device (D2D) communication identifier of the user equipment (UE1);
selecting between connectivity types for delivery of the content to the user equipment (UE1), the connectivity types comprising delivery via the mobile network and delivery via D2D communication;
and if the selected connectivity type comprises D2D communication:
establishing a D2D connection with the user equipment (UE1) using the D2D communication identifier of the user equipment (UE1); and
upon establishment of the D2D connection, delivering the content to the user equipment (UE1) using the D2D connection.

In accordance with a further aspect of the invention, a computer-implemented method may be provided for a user equipment (UE1) to request and receive content from another user equipment (UE2). The method may comprise:
via a mobile network, sending a content request for content to the other user equipment (UE2), wherein the content request comprises a device-to-device (D2D) communication identifier of the user equipment (UE1); and
in response to an establishment of a D2D connection with and at the request of the other user equipment (UE2), identifying whether content delivered via the D2D connection represents an at least partial fulfillment of the content request.

In accordance with a further aspect of the invention, a transitory or non-transitory computer-readable medium may be provided comprising a computer program. The computer program may comprise instructions for causing a processor system to perform one of the computer-implemented methods.

The above measures may involve a device, which is also referred to as UE1 or recipient UE, requesting and receiving content from another device, which is also referred to as UE2 or donor UE. The delivery of the content may at least in part take place via D2D communication between the donor UE and the recipient UE.

For that purpose, the recipient UE may send a request for content delivery to the donor UE. This request may be sent via the mobile network, e.g., via part of the mobile network, and thereby using the mobile network's infrastructure. Here, the term ‘mobile network’ (also known as wireless network) may refer to a telecommunication network which may service mobile UEs, but in some cases also fixed UEs. The identification of the donor UE as having the content requested by the recipient UE may be performed using known techniques. For example, if the donor UE functions as a cache in a CDN, the donor UE may be identified using known a CDN mechanism, e.g., using a DNS of the CDN.

To enable a D2D connection to be established between the recipient UE and the donor UE, the recipient UE may include its D2D communication identifier in the content request. The content request itself may be based on a known type of content request, e.g., a GET request, to which the D2D communication identifier may be added. Such a D2D communication identifier is known per se, and may also be referred to as D2D (link) ID. The donor UE receiving the content request may thus be provided with the D2D communication identifier of the recipient UE, and may use this D2D communication identifier to establish the D2D connection with the recipient UE, if such a connectivity type is selected by the donor UE for content delivery.

Having established the D2D connection with the recipient UE, all or at least part of the requested content may then be delivered via D2D communication, while at the receiving side, the recipient UE may identify whether the content delivered via the D2D connection represents an at least partial fulfillment of the content request.

The above measures have the effect that an existing mechanism for a recipient UE to request content from a donor UE may be extended with functionality to allow the donor UE to deliver the content at least in part via D2D communication to the recipient UE. Specifically, by including the D2D communication identifier in the content request, said identifier may be provided to the donor UE in a reliable and efficient manner. The identification of the donor UE and the transmission of the content request to the donor UE itself may involve existing techniques, for example those known from content delivery networks, and may use the existing mobile network infrastructure. To be able to select D2D communication for content delivery, the functionality of the donor UE may be extended to select between the different connectivity types. Thereby, an efficient mechanism may be provided for enabling content delivery from a donor UE to a recipient UE to take place at least in part via D2D communication.

D2D communication may be established using techniques such as the Proximity-based Services (ProSe) framework [3] (see also ‘Further References’). It is noted that ProSe may allow UEs to find other UEs in their proximity with relevant applications. In standard ProSe, this may involve UEs announcing applications they have or seek, and UEs monitoring the announcements from other UEs. As a part of the announcing of applications, or as a follow-up step, UEs may also specify the content they are seeking or have available. However, in ProSe, the donor UE may have to be discovered ‘bottom up’ again from such announcements by potential donor UEs on applications and (optionally as a part or follow up) content they have available and from announcements by seeking UEs on the content they prefer. It may also happen that a donor UE is discovered that announces an application but doesn't have the content that the recipient UE needs. Compared to the above described measures by which the donor UE is identified and provided with the content request of the recipient UE via the mobile network, this may introduce an inefficient second round of UE discovery before the D2D connection may be established. This inefficiency may be in contradiction with the 3GPP goal for efficient content delivery.

Advantages of the above measures may include, but are not limited to, avoidance of the lengthy discovery request procedures (announce/monitor) of standard ProSe, which may save radio, battery and processing resources at the UEs. In addition, the above measures may provide a distributed architecture for D2D connection setup, e.g., without central elements, which may make the approach independent from the mobile network architecture and therefore more scalable. Furthermore, decisions on the type of connectivity may be made locally at the donor UE (rather than the recipient UE), which may make it possible to take into account the donor UE resources already in use for content distribution to other UEs. This may be particularly relevant if the donor UE serves a larger number of recipient UEs.

The following embodiments relate to the device, and mutatis mutandis to the corresponding computer-implemented method, for delivering content to a recipient UE, but may denote complementary limitations in the processor system and computer-implemented method for requesting and receiving the content.

In an embodiment, the content request may comprise a content identifier which identifies the content requested by the other user equipment (UE1), and the processor subsystem may be configured to provide the content identifier to the other user equipment (UE1) via the D2D connection. The content identifier may allow the recipient UE1 to efficiently identify whether the content delivered via the D2D connection represents an at least partial fulfillment of the content request. Thereby, the identification of the (partial) fulfillment of the content request may be facilitated.

In an embodiment, the processor subsystem may be configured to acknowledge the content request by sending a response to the other user equipment (UE1) via the mobile network, wherein the response may be indicative of the selected connectivity type. The donor UE may select a connectivity type, which may comprise delivery via the mobile network, delivery via D2D communication, and in some embodiments, a combination of both connectivity types. By explicitly or at least implicitly identifying the connectivity type to the recipient UE, the recipient UE may determine if content delivery involves D2D communication, and if so, the recipient UE may be prompted to cooperate in establishing the D2D connection with the donor UE. Otherwise, such a D2D connection may in some cases be refused by the recipient UE, e.g., based on a security policy. Additionally or alternatively, the identification of the connectivity type may enable the recipient UE to better match the content delivered via a particular connectivity type to a (partial) fulfillment of the content request.

In an embodiment, the processor subsystem may be configured to select between the connectivity types based on metadata which may be indicative of a technical feasibility of content delivery using the D2D connection. D2D communication typically relies on a proximity of the donor UE to the recipient UE, and vice versa. D2D communication may not be technically feasible if both UEs are not proximate, and/or for a number of other reasons. In many cases, metadata is or may be made available which may be indicative of the technical feasibility of D2D communication, or specifically of content delivery via a D2D connection. Accordingly, the donor UE may select the most appropriate connectivity type on the basis of such metadata.

In an embodiment, the metadata may comprise at least one of the group of:
location data indicative of an absolute or relative location of either or both user equipment (UE1, UE2);
resource availability data indicative of an availability of radio resources at either or both user equipment (UE1, UE2);
signal strength data indicative of a radio signal strength at either or both user equipment (UE1, UE2);
quality of service data indicative of a quality of service experienced by either or both user equipment (UE1, UE2); and
battery level data indicative of a battery level of either or both user equipment (UE1, UE2).

Such metadata has been found to be indicative of the technical feasibility of content delivery from the donor UE to the recipient UE via D2D communication.

In an embodiment, at least part of the metadata may be received from at least one of the group of:
the other user equipment (UE1) as part of the content request; and
another entity within the mobile network.

At least some of the metadata may be provided by the recipient UE and/or by an entity in the mobile network. For example, the recipient UE may report its location, resource availability, signal strength, experienced QoS and/or battery level to the donor UE. Another example is that the mobile network may report an absolute location of the recipient UE to the donor UE, or a location relative to the donor UE.

In an embodiment, the processor subsystem may be configured to determine if a D2D connection to the other user equipment (UE1) already exists, and if there is an existing D2D connection, reuse the existing D2D connection. In some cases, it may not be needed to establish a D2D connection to the recipient UE, namely if such a D2D connection has already been established, e.g., for a previous delivery of content, or for another reason not related to content delivery per se.

In an embodiment, the connectivity types may further comprise delivery of the content using the mobile network and using D2D communication. For example, part of the content may be delivered via the mobile network, while another part of the content may be delivered via D2D communication. This may, for example, allow faster content delivery compared to delivery using only one of the connectivity types.

In an embodiment, a mobile network may comprise the above-mentioned device, and the mobile network may be configured to establish at least part of a content delivery network and the device may be a cache in the content delivery network.

The following embodiments relate to the device, and mutatis mutandis to the corresponding computer-implemented method, for requesting and receiving content from the donor UE, but may denote complementary limitations in the processor system and computer-implemented method for delivering the content.

In an embodiment, the content request may comprise a first content identifier which identifies the content which is requested, and the processor subsystem may be configured to identify whether the content delivered via the D2D connection represents the at least partial fulfillment of the content request by comparing the first content identifier to a second content identifier which is provided by the other user equipment (UE2) via the D2D connection. By the donor UE providing a content identifier identifying the delivered content to the recipient UE, and the recipient UE comparing this content identifier to a content identifier of the requested content, the recipient UE may determine whether the content delivered via the D2D connection represents an at least partial fulfillment of the content request.

In an embodiment, the user equipment (UE1) may be configured to receive a response from the other user equipment (UE) via the mobile network, wherein the response represents an acknowledgement of the content request and comprises a D2D communication identifier of the other user equipment (UE2), and the processor subsystem may be configured to identify whether the content delivered via the D2D connection represents the at least partial fulfillment of the content request based on the D2D connection being established to an entity having a D2D communication identifier which matches the D2D communication identifier of the other user equipment (UE2). The donor UE may acknowledge the content request, e.g., using a known response mechanism, such as sending a GET response. By including the D2D communication identifier of the donor UE in the response, the recipient UE may associate the D2D connection, and thereby content delivered via the D2D connection, with the content request which has been sent to the donor UE. This may allow the recipient UE to determine whether the content delivered via the D2D connection represents an at least partial fulfillment of the content request.

In an embodiment, the processor subsystem may be configured to include metadata in the content request which is indicative of a technical feasibility of the D2D connection. Such metadata may allow the donor UE to determine a technical feasibility of content delivery via the D2D connection. Examples of such metadata include, but are not limited, to location data, resource availability data, signal strength data, data indicative of an experienced QoS and/or battery level data of the recipient UE.

In an embodiment, the content request may be for a content segment, and the processor subsystem may be configured to send further content requests for further content segments to the further user equipment (UE2) via the D2D connection. Once the D2D connection is established, following content requests may be sent directly to the donor UE via the D2D connection, instead of being sent via the mobile network.

In accordance with a further aspect of the invention, a transitory or non-transitory computer-readable medium may be provided comprising structured data representing a content request. The content request may comprise at least one of the group of:
a device-to-device (D2D) communication identifier of a first user equipment (UE1);
metadata which is indicative of a technical feasibility of a D2D connection between the first user equipment (UE1) and a second user equipment (UE2), for example comprising at least one of the group of:
   location data indicative of an absolute or relative location of either or both user equipment (UE1, UE2);
   resource availability data indicative of an availability of radio resources at either or both user equipment (UE1, UE2);
   signal strength data indicative of a radio signal strength at either or both user equipment (UE1, UE2);
   quality of service data indicative of a quality of service experienced by either or both user equipment (UE1, UE2); and
   battery level data indicative of a battery level of either or both user equipment (UE1, UE2).

It will be appreciated by those skilled in the art that two or more of the above-mentioned embodiments, implementations, and/or aspects of the invention may be combined in any way deemed useful.

Modifications and variations of any one of the devices or UEs, methods and/or the computer programs, which correspond to the described modifications and variations of another device or UE, method or computer program, may be carried out by a person skilled in the art on the basis of the present description.

### Further References

[3] 3rd Generation Partnership Project; Technical Specification Group Services and System Aspects; Proximity-based services (ProSe); Stage 2 (Release 15), 3GPP TS 23.303 V15.1.0 (2018 June)

### BRIEF DESCRIPTION OF THE DRAWINGS

These and other aspects of the invention are apparent from and will be elucidated with reference to the embodiments described hereinafter. In the drawings,

FIG. 1 shows a system in which content is requested using a mobile network and delivered using a D2D connection which is established on the basis of a D2D communication identifier included in the content request;

FIG. 2 shows a system for content delivery using D2D communication, in which a response to the content request is provided using the mobile network, and wherein the response indicates that the content is delivered using D2D communication;

FIG. 3. shows a system for content delivery using D2D communication, in which the content request contains a content identifier, and in which the content identifier is added to the content delivered via the D2D connection;

FIG. 4 shows a system for content delivery using D2D communication, in which the content request contains metadata representing additional metrics associated with the technical feasibility of content delivery via a D2D connection;

FIG. 5 illustrates a request for further content which is provided via the D2D connection and with the further content being delivered via the D2D connection;

FIG. 6 shows a system for content delivery using D2D communication, in which the content request is sent via a relay, such as a NAT-based relay;

FIG. 7 shows an example of a data structure of a content request;

FIG. 8 shows a flow diagram representing a computer-implemented method for delivering content using a D2D connection;

FIG. 9 shows a flow diagram representing a computer-implemented method for requesting and receiving content using a D2D connection;

FIG. 10 shows a computer readable medium comprising data; and

FIG. 11 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### LIST OF REFERENCE AND ABBREVIATIONS

The following list of references and abbreviations is provided for facilitating the interpretation of the drawings and shall not be construed as limiting the claims.

CDN content delivery network

D2D device-to-device

DNS domain name server

IP internet protocol

NAT network address translation

UE1, UE2 user equipment

URI Uniform Resource Identifier

URL Uniform Resource Location

1 resolve (content URL)

2 response (IP address of UE2)

3, 3a, 3b get (content URI, D2D ID UE1, geo)

3′ get (content URI, D2D ID UE1, geo, metrics)

4 select connectivity type

4a response (content URI, D2D ID UE2, connectivity type)

5 D2D setup (D2D ID UE1, content URI)

5′ D2D setup (D2D ID UE1, content URI, D2D ID UE2)

5″ D2D setup (D2D ID UE1)

6 identify relation between get and D2D setup

6′ content transfer (content URI)

7 content transfer

7′ identify relation between get and content transfer

8 get (further content URI)

9 select connectivity type

10 content transfer (further content URI)

11 identify relation between get and content transfer

20 mobile network infrastructure

40 content delivery network system

42 domain name server

100 user equipment 1

120 network interface to mobile network

140 D2D communication interface

160 processor subsystem

200 user equipment 2

220 network interface to mobile network

240 D2D communication interface

260 processor subsystem

280 cache

300 content request data structure

400 method for delivering content

410 receiving content request via mobile network

420 selecting connectivity type

430 establishing D2D connection

440 delivering content using D2D connection

500 method for requesting and receiving content

510 sending content request via mobile network

520 receiving content via D2D connection

530 identify whether content request is fulfilled

600 computer readable medium

610 non-transitory data

1000 exemplary data processing system

1002 processor

1004 memory element

1006 system bus

1008 local memory

1010 bulk storage device

1012 input device

1014 output device

1016 network adapter

1018 application

### DETAILED DESCRIPTION OF EMBODIMENTS

The following embodiments relate to content delivery from a donor UE (also referred to as UE2 or donor UE2) to a recipient UE (also referred to as UE1 or recipient UE), and may generally involve the recipient UE sending a content request to the donor UE via a mobile network while including a D2D communication identifier of the recipient UE in the content request. The D2D communication identifier may be used by the donor UE to select and establish a D2D connection to the recipient UE, e.g., if technically feasible, and deliver the content at least in part via the D2D connection.

It is noted that while the following embodiments are described within the context of the donor UE representing a cache in a content delivery network (CDN) and being identified to the recipient UE using the CDN, and in particular using a domain name server (DNS) of the CDN, the use of a CDN is not a requirement, in that other known mechanisms which can translate content identifiers or names to one or multiple content locators may be used instead for enabling the recipient UE to send a request for content via a mobile network to a donor UE offering the content. For example, HTTP URL Redirection may be used or even a direct content request, for example based on static configuration, between UEs via the mobile network, is not precluded. The following measures are therefore not limited to CDN systems.

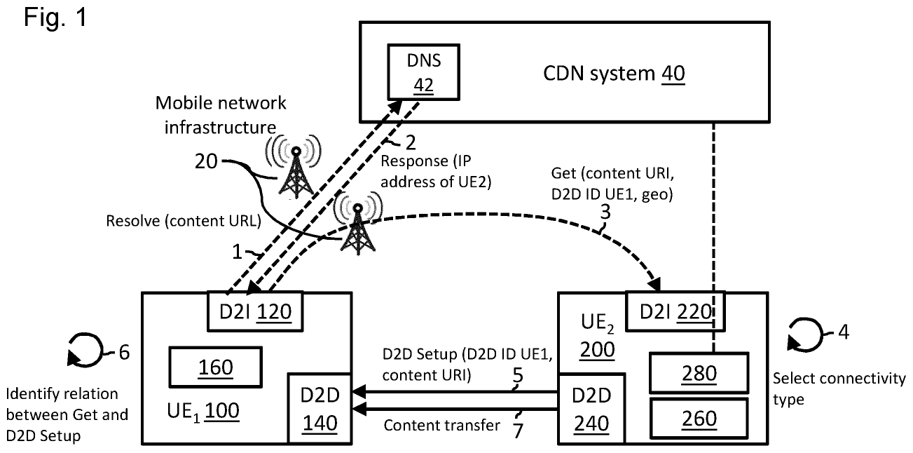

FIG. 1 shows a first embodiment of a system in which content is requested using a mobile network and delivered using a D2D connection which is established on the basis of a D2D communication identifier included in the content request.

As previously indicated, the donor UE (UE2, 200) may be considered to be ‘part’ of a CDN system 40, in the sense that UE2 200 may cache content from the CDN system 40. UEs that seek content, such as the depicted recipient UE (UE1, 100), may obtain information from the CDN system 40 on an optimal network node offering the content and the route to that network node through standard CDN procedures, e.g. based on a DNS 42 resolving a content URL to an IP address of the network node. The DNS 42 may be partly outside (not shown) and partly inside the CDN system 40. It is noted that a DNS Query based on a content URL is one of the mechanisms that CDNs may use, but others exist as well and may be used instead of such a DNS Query.

UE1 and UE2 may each have mobile network connectivity, enabling data communication via the mobile network infrastructure 20, with such type of data communication being indicated with dashed line arrows in FIGS. 1-6. Furthermore, UE1 and UE2 may each be capable of setting up D2D connections, indicated with full line arrows in FIGS. 1-6. Furthermore, UE1 and UE2 may each have been authorized for D2D connectivity, for example through standard ProSe [3] authentication steps that involve a Prose function (not shown in FIG. 1). In addition, UE1 and UE2 may each have generated or otherwise obtained respective D2D communication identifiers.

The embodiment shown in FIG. 1 may involve the following steps, of which the numbering corresponds to reference numbers in FIG. 1.

1. UE1 may need content which is identified by a content URI. From the content URI, a content URL may be derived using existing approaches. Typically, the URL may be contained inside the content URI. In step 1, UE1 may send a DNS query to the DNS 42 using a message labeled ‘Resolve (content_url)’ to identify a network node that has the desired content.

2. The DNS 42 may return the IP address of UE2 using a message labeled ‘Response (IP address of UE2)’. The IP address may be a public or private IP address. Instead of an IP address, another type of network address may be used as well.

3. UE1 may send a Get request for the content to UE2 via a connection over the mobile network infrastructure 20. The Get request, which is labeled ‘Get (content URI, D2D ID UE1, geo)’, may include geolocation data of UE1 (e.g., its GPS location, as also discussed elsewhere) and its D2D communication identifier.

4. Upon receipt of the request, UE2 may select the type of connectivity to be used for the delivery of the content to UE1, as represented in FIG. 1 by a labeled arrow ‘Select connectivity type’. UE2 may for example choose between content delivery via the mobile network infrastructure 20, via a D2D connection, or using both. The selection may depend on various factors, such as the geographical proximity of UE1 to UE2. In this particular example, UE2 selects D2D connectivity as UE1 may be nearby.

5. UE2 may set up a D2D connection to UE1 using message(s) labeled ‘D2D Setup (D2D ID UE1, content URI)’. For that purpose, UE1 may be identified in ProSe by its D2D communication identifier, using ProSe one-to-one communication (e.g., according to TS 23.303 [3] section 5.4.5). This may not need to involve any ProSe discovery steps. UE2 may include the content URI in the setup message(s).

6. UE1 may identify that the D2D connection which is being set up, or which has been setup is related to its earlier Get request, for example based on the content URI sent by UE2, see the arrow labeled ‘Identify relation between Get and D2D Setup’. As such, this step may overlap in time step 5, or may be performed afterwards.

7. The content may be transferred (also referred as ‘delivered’) from UE2 to UE1 via the established D2D connection, see the arrow labeled ‘Content transfer’.

It will be appreciated that while steps 1 and 2 may involve the use of existing CDN systems and procedures, UE1 may now be extended in terms of functionality, compared to known UEs interacting with CDN and similar systems, to include a D2D communication identifier in the content request (step 3), while UE2 may be extended with functionality to select the connectivity type (step 4) and to establish the D2D connection using the received D2D communication identifier of UE1 (step 5). Furthermore, UE1 may be extended with functionality to identify the relation between the earlier content request and the D2D connection which is (being) set up (step 6).

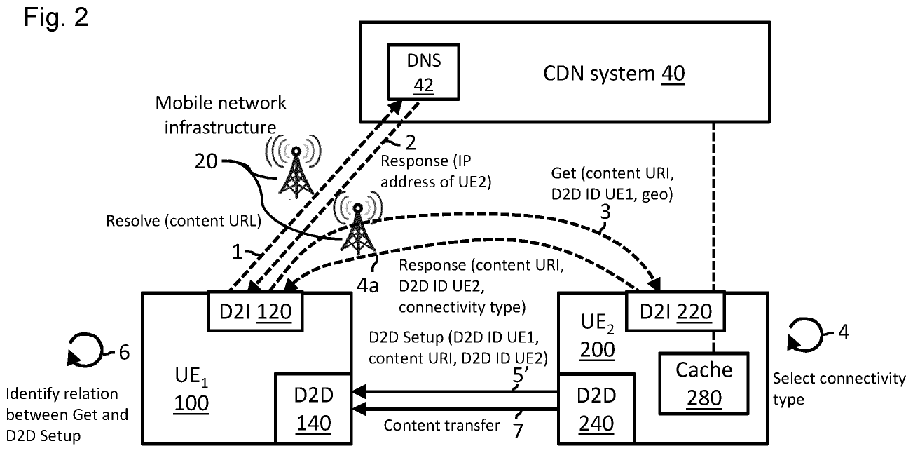

FIGS. 1-6 shows various internal components of UE1 and UE2, such as network interfaces 120, 220 (labeled D2I′ in FIG. 1 referring to a Device-To-Infrastructure interface, e.g., an interface to the mobile network infrastructure, with D2I′), D2D communication interfaces 140, 240, processor subsystems 160, 260 and a cache 280. These components will be further discussed elsewhere, while in FIGS. 2-6, the processor subsystems are not separately shown for conciseness. In FIGS. 2-6, steps which are identified by the same reference numbers as described for FIG. 1 correspond to the steps described for FIG. 1, unless otherwise noted or implied.

FIG. 2 shows a system for content delivery using D2D communication, in which a response to the content request is provided using the mobile network 20, and wherein the response indicates that the content will be delivered using D2D communication. In particular, UE2 may inform UE1 about the connectivity type selected in step 4, e.g., D2D connectivity or connectivity via the mobile network. This information may be carried in a response message in a step 4a labelled ‘Response (content URI, D2D ID UE2, connectivity type)’, which may be sent by UE2 after the selection of the connectivity type in step 4. More specifically, this information may be carried a “connectivity type” field in the response message. The message may also include the content URI and the D2D communication identifier of UE2, which may facilitate UE1 in identifying the relation between the Get message of step 3 and the D2D content setup of step 5. In particular, the D2D communication identifier of UE2 may also be contained in the D2D setup message as a modification of step 5, which is further referred to as 5′ and which is labeled ‘D2D Setup (D2D ID UE1, content URI, D2D ID UE2)’. UE1 may then identify the relation between the content request and the content delivered via the D2D connection on the basis of both identifiers (e.g. of steps 4a and 5′) matching.

In yet another embodiment, there may be additional messages exchanged between UE1 and UE2, e.g., as extensions to the Get and response messages 3, 4a described above, which may contain information on the progress of the selection carried out by UE2 in step 4, or which may provide a confirmation of the receipt of the Get message by UE2, or a further confirmation of the response message 4a by UE1.

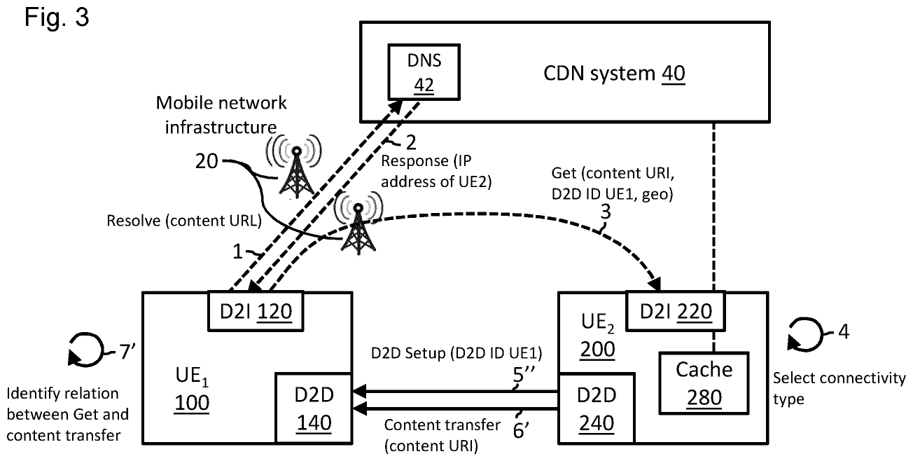

FIG. 3. shows a system for content delivery using D2D communication, in which the content request contains a content identifier, and in which the content identifier is added to the content delivered via the D2D connection. More specifically, in this embodiment, a content identifier, such as a content URI, which may be used by UE1 to identify the desired content URL in step 1, may be added to the content transferred in step 6′ (a modified version of step 7 of the embodiment of FIG. 1). Accordingly, step 6′ is now labeled ‘Content transfer (content URI)’. The content identifier may then be used in step 7′ (a modified version of step 6 of the embodiment of FIG. 1) to identify the relation between the Get message in step 3 and the content transferred in step 6′. Accordingly, step 7′ is now labeled ‘Identify relation between Get and content transfer’. It may therefore not be needed to provide the content identifier in step 5, and as such a modified step 5″ labeled ‘D2D Setup (D2D ID UE1)’ may omit the content identifier.

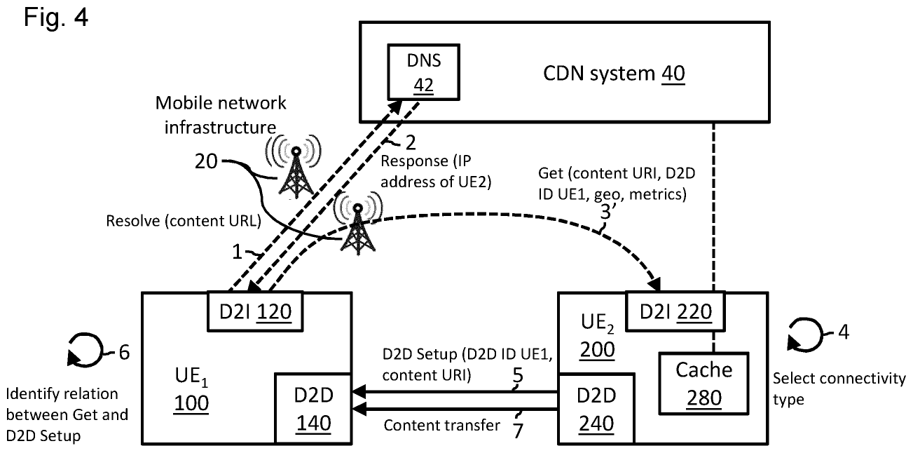

FIG. 4 shows a system for content delivery using D2D communication, in which the content request contains metadata representing additional metrics associated with the technical feasibility of content delivery via a D2D connection. More specifically, apart from the geographical location of UE1, the selection of UE2 of the connectivity type to be used for the transfer of the content requested by UE1 to UE1 may depend on several metrics, including but not limited to:
The availability of radio resources as experienced by UE2 and/or UE1
The radio signal strengths as experienced by UE2 and/or UE1
The Quality of Service (QoS) parameters that UE2 and/or UE1 experiences over the mobile network links and the D2D links being used. The QoS parameters may for example include: bandwidth, latency, jitter.
The current battery level of UE2 and/or UE1.

Such types of information may be obtained in the form of metadata. For example, metadata pertaining to UE1 may be provided by UE1 in an additional metrics data structure in the Get message in step 3′ (a modified version of step 3 of the embodiment of FIG. 1). Accordingly, step 3′ is now labeled ‘Get (content URI, D2D ID UE1, geo, metrics)’. Additionally or alternatively, such type of metadata may be obtained from one or more entities in the mobile network, as also discussed elsewhere.

UE2 may use such type of information to select the connectivity type. This may involve the use of a rule-based system, e.g., applying thresholds to metrics or comparing metrics between UE1 and UE2. Various other types of selection mechanisms are equally conceivable. For example, a machine learned model may be used to select an appropriate connectivity type based on said information as input.

In general, content may be split in several sequential segments. The segments may for example be time sequential, e.g., forming a video stream or an audio stream. After UE1 has received a first content segment (which may also be simply considered ‘content’), it may therefore request a further content segment (which may also be considered ‘further content’) according to the procedures described above.

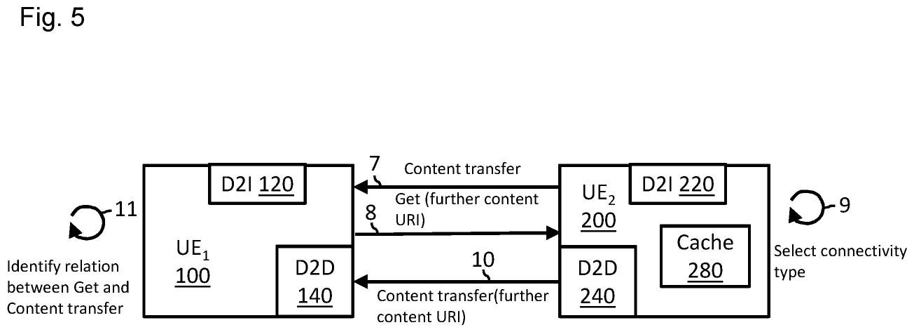

FIG. 5 shows another embodiment, in which UE1 requests the further content segment over the D2D connection, e.g., in a step 8 and corresponding message labeled ‘Get (further content URI)’, rather than over the mobile network connection. UE2 may then select the connectivity type in step 9, which may otherwise correspond to step 4 as previously described. If UE2 selects D2D communication as connectivity type, the further content may be transferred to UE1 in step 10 labeled ‘Content transfer (further content URI)’. The content transfer may include the identifier of the further content, e.g., the further content URI, which may be used by UE1 in step 11 to identify the relation between the Get of step 8 and the content transfer of step 10. Step 11 may otherwise correspond to step 6 as previously described.

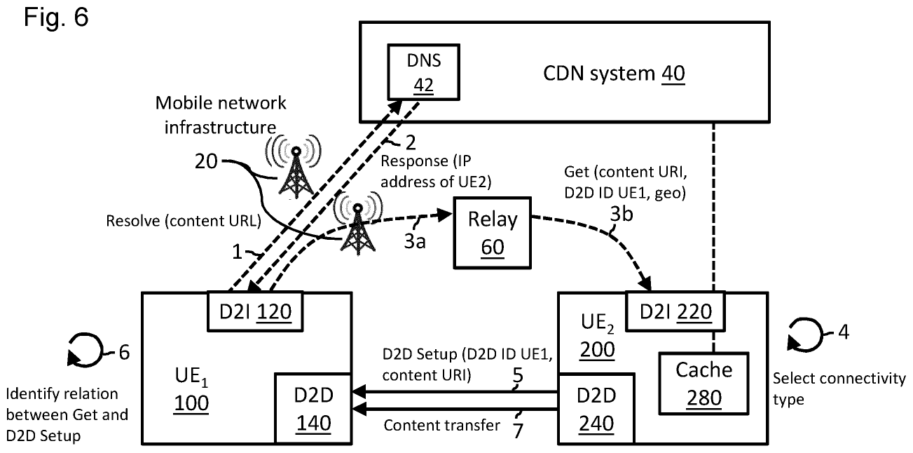

FIG. 6 shows a system for content delivery using D2D communication, in which the content request is sent via a relay 60. This relay 60, which may also be referred to as relay node or relay function, may be positioned in the path between UE1 and UE2. In some examples, the relay may provide NAT (Network Address Translation) which may translate a network address, such as an IP address which is used by UE1 to address UE2, from a public IP address to a private IP address or vice versa. The relay may also provide security functions or filtering functions that may shield UE1 or UE2 from unwanted messages. Accordingly, the Get message previously referenced by numeral 3 may now be transmitted via the relay 60 via steps 3a, 3b.

The following describes embodiments with continued reference to FIG. 1.

### Multiple IP Addresses Returned by CDN System

In an embodiment, the CDN system 40 may return a list of IP addresses of potential donor UEs rather than a single IP address in the response of step 2, or otherwise identify a number of donor UEs. The list may have an order that indicates the preference or priority for the IP addresses and thereby the donor UEs to be used by UE1. UE1 may try to approach the donor UEs with a Get message (step 3) in the indicated order or determine the preferred order by itself. As such, if a donor UE proves to be unreachable by UE1, UE1 may attempt to reach alternative donor UEs.

### One-To-Many Communication

If in step 3 UE2 receives a request for content that UE2 has already received a request for within a given predetermined timeframe, UE2 may decide in step 4 to use a D2D one-to-many communication mode (e.g., a broadcast communication mode) to efficiently deliver the content to multiple recipient UEs. In particular, the D2D one-to-many communication may save radio resources compared to multiple D2D one-to-one communications. An example situation is a stadium case where many people wish to see the same content at or around the same time. The D2D one-to-many communication may be implemented using the One-to-many ProSe Direct Communication procedures from TS 23.303 [3] section 5.4 but also via other methods. In an embodiment, UE2 may wait for a predetermined time after receiving the Get request in step 3 for further UEs requesting the same content to determine whether one-to-many communication should be used. In another embodiment, UE2 may terminate one-to-one communication with a first UE and set up one-to-many communication with that first UE and another UE which requests the same content.

### Parallel Use of D2D Connection and Connection Via Mobile Network

In an embodiment, UE2 may decide to use both a D2D connection and a connection over the mobile network to transfer the content to UE1. This may provide a higher bandwidth and may increase the stability of the overall connectivity between UE1 and UE2. The D2D connection may be set up using the procedures described above, while the connection over the mobile network may be set up using, e.g., the procedures described in 3GPP standards. The connections may be used in combination using standard channel bonding or link aggregation techniques.

### Mobile Network as a Source for Location Information

In an embodiment, the geographical location of UE1 that may be sent by UE1 to UE2 in step 3 may be obtained from a Global Positioning System (GPS) or equivalent (Galileo, Glonass) function implemented on UE1. In an alternative embodiment, the location may be obtained from the mobile network, which may have a view on the approximate location of the UEs based on the cells they are in. The method for obtaining the location of UE1 may be based on the ProSe procedures for UE Location Reporting from TS 23.303 [3] section 5.5.6, in which the UEs report their locations to SLPs (SUPL Location Platforms) which in turn report the locations to ProSe functions. Through these procedures, UE2 may be informed of the geographical proximity of UE1 based on sources in the mobile network. This approach may be used if for example UE1 has no GPS or equivalent function, or no GPS fix.

### Fallback to Connection Via Mobile Network Outside D2D Coverage

The performance of the D2D connection may deteriorate, e.g., if the distance between UE1 and UE2 increases due to movement or if obstacles affect the transmission of radio signals. In an embodiment, upon detecting a deterioration that exceeds a certain threshold, UE2 may decide to terminate the use of the D2D connection and deliver the content to UE1 via a connection over the mobile network.

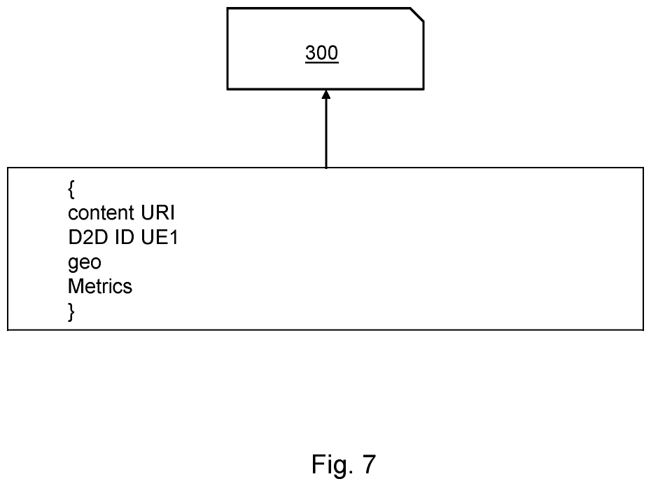

FIG. 7 shows an example of a data structure of a content request, which may for example be a HTTP GET request. The data structure is shown to comprise data fields for the content URI, the D2D communication identifier of UE1, geo-information such as a GPS location, and additional metrics as explained elsewhere.

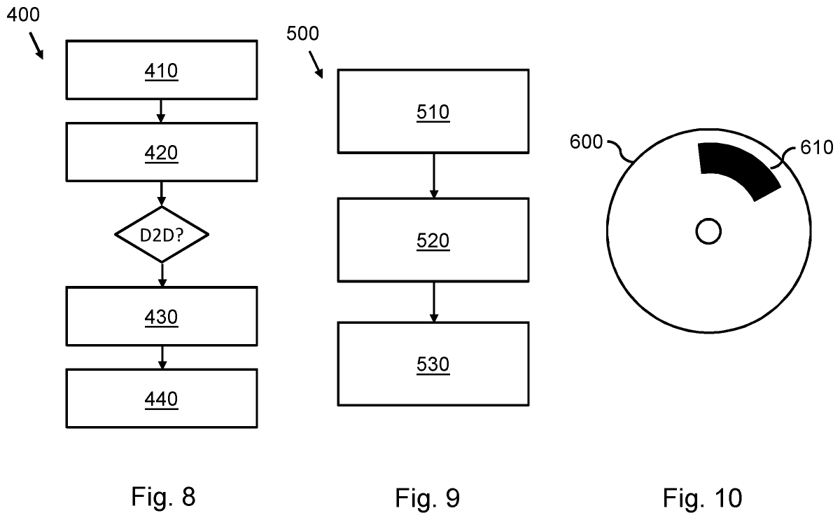

FIG. 8 shows a flow diagram representing a computer-implemented method 400 for delivering content using a D2D connection. The method 400 may comprise, in a step titled “RECEIVING CONTENT REQUEST VIA MOBILE NETWORK”, receiving 410, via a mobile network, a content request for delivery of content from the user equipment, wherein the content request comprises a device-to-device communication identifier of the user equipment. The method 400 may further comprise, in a step titled “SELECTING CONNECTIVITY TYPE”, selecting 420 between connectivity types for delivery of the content to the user equipment, wherein the connectivity types comprise delivery via the mobile network and delivery via D2D communication. The method 400 may further comprise, if the selected connectivity type comprises D2D communication (“D2D?” in FIG. 8), in a step titled “ESTABLISHING D2D CONNECTION”, establishing 430 a D2D connection with the user equipment using the D2D communication identifier of the user equipment, and in a step titled “DELIVERING CONTENT USING D2D CONNECTION” and upon establishment of the D2D connection, delivering 440 the content to the user equipment using the D2D connection.

FIG. 9 shows a flow diagram representing a computer-implemented method 500 for requesting and receiving content using a D2D connection. The method 500 may comprise, in a step titled “SENDING CONTENT REQUEST VIA MOBILE NETWORK”, sending 510, via a mobile network, a content request for content to the other user equipment, wherein the content request comprises a device-to-device communication identifier of the user equipment. The method 500 may further comprise, in a step titled “IDENTIFY WHETHER CONTENT REQUEST IS FULFILLED” and in response the establishment of a D2D connection with and at the request of the other user equipment, identifying 530 whether content delivered via the D2D connection represents an at least partial fulfillment of the content request. It is noted that FIG. 9 explicitly shows the receiving 520 of the content as a separate step titled “RECEIVING CONTENT VIA D2D CONNECTION”. However, while the receipt of the content may be considered a prerequisite for step 530, it may not need to be part of the method 500 itself, e.g., it may also be performed by another computer-implemented method.

It will be appreciated that, in general, the operations or steps of method 400 of FIG. 8 and/or method 500 of FIG. 9 may be performed in any suitable order, e.g., consecutively, simultaneously, or a combination thereof, subject to, where applicable, a particular order being necessitated, e.g., by input/output relations.

It is noted that any of the methods described in this specification, for example in any of the claims, may be implemented on a computer as a computer implemented method, as dedicated hardware, or as a combination of both. Instructions for the computer, e.g., executable code, may be stored on a computer readable medium 600 as for example shown in FIG. 10, e.g., in the form of a series 610 of machine-readable physical marks and/or as a series of elements having different electrical, e.g., magnetic, or optical properties or values. The executable code may be stored in a transitory or non-transitory manner. Examples of computer readable mediums include random access or read only memory devices, optical storage devices, integrated circuits, etc. FIG. 10 shows by way of example an optical storage device 600.

In an alternative embodiment of the computer readable medium 600 of FIG. 10, the computer readable medium 600 may comprise transitory or non-transitory data 610 representing the content request or the metadata described in this specification.

### Data Processing Entities

With continued reference to FIG. 1 and others, the recipient UE (UE1) and the donor UE (UE2) may each comprise a network interface 120, 220 for communicating via the mobile network. The network interface 120, 220 may take any suitable form, including but not limited to a 4G or 5G mobile communication interface. UE1 and UE2 may each comprise a D2D communication interface 140, 240 for communicating via D2D communication. The D2D communication interface 140, 240 may take any suitable form, including but not limited to NR (5G) Direct, LTE Direct, WiFi Direct, WiFi NAN, Bluetooth, etc. UE1 and UE2 may each comprise a processing subsystem 160, 260 which may be configured, e.g., by hardware design or software, to perform the operations described with reference to FIGS. 1-6 and elsewhere in as far as pertaining to the functionality of the respective UE. For example, each processing subsystem 160, 260 may be embodied by a single Central Processing Unit (CPU), but also by a combination or system of such CPUs and/or other types of processing units. UE2 is further shown to comprise a cache 280 for content, which may comprise or may be represented by a data storage, such as a hard drive, solid state disk, a memory, and/or an array or other combination thereof. In general, UE1 and UE2 may each be embodied by a (single) device or apparatus, e.g., an end-user device such as smartphone, personal computer, laptop, tablet device, gaming console, set-top box, television, monitor, projector, smart watch, smart glasses, media player, media recorder, head mounted display device, etc. However, UE1 and UE2 may each also be embodied by a distributed system of devices or apparatuses.

In general, UE1 and UE2 may each be implemented at least in part by a device or apparatus. The device or apparatus may comprise one or more (micro)processors which execute appropriate software. Software implementing the functionality of the function(s) may have been downloaded and/or stored in a corresponding memory or memories, e.g., in volatile memory such as RAM or in non-volatile memory such as Flash. Alternatively, the function(s) may be implemented in the device or apparatus in the form of programmable logic, e.g., as a Field-Programmable Gate Array (FPGA). In general, each function may be implemented as a circuit.

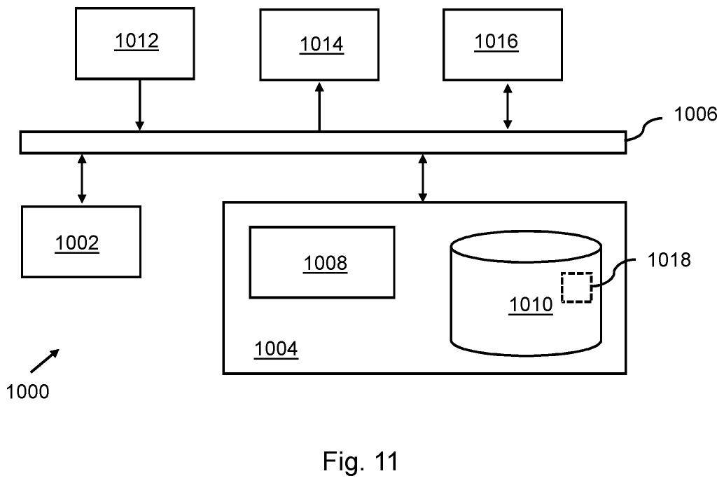

FIG. 11 is a block diagram illustrating an exemplary data processing system that may be used in the embodiments described in this specification. Such data processing systems include data processing entities described in this specification, including but not limited to the recipient UE (UE1) and the donor UE (UE2).

The data processing system 1000 may include at least one processor 1002 coupled to memory elements 1004 through a system bus 1006. As such, the data processing system may store program code within memory elements 1004. Further, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification.

Memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The processing system 1000 may also include one or more cache memories (not shown) that provide temporary storage of at least some program code in order to reduce the number of times program code must be retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, a game controller, a Bluetooth controller, a VR controller, and a gesture-based input device, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 1000.

As shown in FIG. 11, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail.

In one aspect, for example, data processing system 1000 may implement the recipient UE (UE1). In that case, application 1018 may represent an application that, when executed, configures data processing system 1000 to perform the functions described herein with reference to the recipient UE. In another aspect, data processing system 1000 may implement the donor UE (UE2). In that case, application 1018 may represent an application that, when executed, configures data processing system 1000 to perform the functions described herein with reference to the donor UE.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A device configured as user equipment for a mobile network and configured for delivering content to another user equipment,
wherein the device comprises:
a network interface configured to interface with the mobile network;
a device-to-device (D2D) interface configured for D2D communication;
a processor subsystem configured to:
via the mobile network, receive a content request for content from the other user equipment (UE1), wherein the content request comprises a D2D communication identifier of the other user equipment;
select between connectivity types for delivery of the content to the other user equipment, the connectivity types comprising delivery via the mobile network and delivery via D2D communication;
and if the selected connectivity type comprises D2D communication
establish a D2D connection with the other user equipment using the D2D communication identifier of the other user equipment;
upon establishment of the D2D connection, deliver the content to the other user equipment using the D2D connection.

2. The device according to claim 1, wherein the content request comprises a content identifier which identifies the content requested by the other user equipment, and wherein the processor subsystem is configured to provide the content identifier to the other user equipment via the D2D connection.

3. The device according to claim 1, wherein the processor subsystem is configured to acknowledge the content request by sending a response to the other user equipment via the mobile network, wherein the response is indicative of the selected connectivity type.

4. The device according to claim 1, wherein the processor subsystem is configured to select between the connectivity types based on metadata which is indicative of a technical feasibility of content delivery using the D2D connection.

5. The device according to claim 4, wherein the metadata comprises at least one of the group of:
location data indicative of an absolute or relative location of either or both user equipment;
resource availability data indicative of an availability of radio resources at either or both user equipment;
signal strength data indicative of a radio signal strength at either or both user equipment;
quality of service data indicative of a quality of service experienced by either or both user equipment; and
battery level data indicative of a battery level of either or both user equipment.

6. A device configured as user equipment for a mobile network and configured for requesting and receiving content from another user equipment,
wherein the device comprises:
a network interface configured to interface with the mobile network;
a device-to-device (D2D) interface configured for D2D communication;
a processor subsystem configured to:
via the mobile network, send a content request for content to another user equipment, wherein the content request comprises a D2D communication identifier of the user equipment; and
in response to an establishment of a D2D connection with and at the request of the other user equipment, identify whether content delivered via the D2D connection represents an at least partial fulfillment of the content request.

7. The device according to claim 6, wherein the content request comprises a first content identifier which identifies the content which is requested, and wherein the processor subsystem is configured to identify whether the content delivered via the D2D connection represents the at least partial fulfillment of the content request by comparing the first content identifier to a second content identifier which is provided by the other user equipment via the D2D connection.

8. The device according to claim 6, configured to receive a response from the other user equipment via the mobile network, wherein the response represents an acknowledgement of the content request and comprises a D2D communication identifier of the other user equipment, and wherein the processor subsystem is configured to identify whether the content delivered via the D2D connection represents the at least partial fulfillment of the content request based on the D2D connection being established to an entity having a D2D communication identifier which matches the D2D communication identifier of the other user equipment.

9. The device according to claim 6, wherein the processor subsystem is configured to include metadata in the content request which is indicative of a technical feasibility of content delivery using the D2D connection.

10. The device according to claim 6, wherein the content request is for a content segment, and wherein the processor subsystem is configured to send further content requests for further content segments to the further user equipment (UE2) via the D2D connection.

11. A mobile network comprising the device according to claim 1, wherein the mobile network is part of or configured to support a content delivery network, wherein the device is a cache in the content delivery network.

12. A transitory or non-transitory computer-readable medium comprising structured data representing a content request, wherein the content request comprises at least one of the group of:
a device-to-device (D2D) communication identifier of a first user equipment;
metadata which is indicative of a technical feasibility of a D2D connection between the first user equipment and a second user equipment, for example comprising at least one of the group of:
location data indicative of an absolute or relative location of either or both user equipment;
resource availability data indicative of an availability of radio resources at either or both user equipment;
signal strength data indicative of a radio signal strength at either or both user equipment;
quality of service data indicative of a quality of service experienced by either or both user equipment; and
battery level data indicative of a battery level of either or both user equipment.

13. A computer-implemented method for delivering content to a user equipment, the method comprising:
via a mobile network, receiving a content request for delivery of content from the user equipment, wherein the content request comprises a device-to-device (D2D) communication identifier of the user equipment;
selecting between connectivity types for delivery of the content to the user equipment, the connectivity types comprising delivery via the mobile network and delivery via D2D communication;
and if the selected connectivity type comprises D2D communication:
establishing a D2D connection with the user equipments using the D2D communication identifier of the user equipment; and
upon establishment of the D2D connection, delivering the content to the user equipment using the D2D connection.

14. A computer-implemented method for a user equipment to request and receive content from another user equipment, the method comprising:
via a mobile network, sending a content request for content to the other user equipment, wherein the content request comprises a device-to-device (D2D) communication identifier of the user equipment; and
in response an establishment of a D2D connection with and at the request of the other user equipment, identifying whether content delivered via the D2D connection represents an at least partial fulfillment of the content request.

15. A transitory or non-transitory computer-readable medium comprising a computer program, the computer program comprising instructions for causing a processor system to perform the method according to claim 13.
